(19) United States
(12) Patent Application Publication
(10) Pub. No.: US 2006/0065606 A1
(43) Pub. Date: Mar. 30, 2006

(54) Modular wastewater remediation system and method of using

(75) Inventor: Dennis McGuire, Stuart, FL (US)

Correspondence Address: MCHALE & SLAVIN, P.A., 2855 PGA BLVD, PALM BEACH GARDENS, FL, 33410, US

(73) Assignee: Ultrastrip Systems, Inc., Stuart, FL (US)

(21) Appl. No.: 11/075,844

(22) Filed: Mar. 7, 2005

Related U.S. Application Data
(60) Provisional application No. 60/551,481, filed on Mar. 5, 2004.

(51) Int. Cl. C02F 1/68

(52) U.S. Cl. 210/749

(57) ABSTRACT

This invention relates to a modular wastewater treatment system that uses multiple treatment units to neutralize or remove contaminants in the wastewater generated during site cleanup or decontamination activities; particularly to the treatment of wastewater from the cleanup or decontamination of biohazard or homeland security events, wherein the treatment is adaptable to the site specific conditions related to the biological or chemical agent used in the attack and to the cleanup method being used.

This application relies upon provisional application 60/551,481 filed Jul. 19, 2004, the contents of which are incorporated herein by reference.

### FIELD OF THE INVENTION

This invention relates to a modular wastewater treatment system that uses multiple treatment processes to neutralize or remove contaminants in the wastewater generated during site cleanup or decontamination activities; particularly to the treatment of wastewater generated from the cleanup or decontamination of biohazardous terrorist or homeland security events, wherein the treatment is adaptable to the site specific conditions related to the biological or chemical agent used in the attack and to the cleanup method being used.

### BACKGROUND OF THE INVENTION

Technology designed for the treatment of wastewater from the cleanup or decontamination of a biohazardous or homeland security events can vary widely, and generally must be adapted to the site specific conditions related to the biological or chemical agent used in the attack and to the cleanup method being used. While the target constituents may vary and specific technology unit processes may change in a given application, many common factors will impact all site decontamination projects. Typically, the technology handles dirt, grit, oily residues, soluble organics, and the strong cleaning solutions used to clean the site surfaces. Requirements for the treated effluent will include the ability to meet federal, state, and local standards for general contaminants as measured by common indicator parameters, such as alkalinity, surfactants (MBAS), oil and grease (O&G), total suspended solids (TSS), 5-day biochemical oxygen demand (BOD₅), chemical oxygen demand (COD), ammonia, total Kjeldahl nitrogen (TKN), and total phosphorus.

Currently the typical technologies being applied or considered for treating these biohazardous wastewaters include: chemical treatment (reaction, neutralization, coagulation, etc.), solids separation (centrifuge, sedimentation, filtration), carbon adsorption, E33 media filtration, ultra filtration, reverse osmosis, and similar processes. In most applications, a combination of these technologies is needed to address the multiple constituents that are present in the wastewater.

Exemplary prior art treatment systems are illustrated by U.S. Pat. No. 5,407,572, which is directed toward a systemic tertiary effluent polishing system including chlorine contact, mixed media filtration, and backwash storage.

The inherent problem in treating incidents of bioterrorism or the like lies in the fact that a high degree of disinfection is required, which then makes downstream treatment problematic, given that the halogen disinfection agent, typically chlorine, must be used at extremely elevated levels. When, for example, a municipal water supply must be decontaminated in order to return the effluent to service, such treatments as reverse osmosis and ultrafiltration become inaccessible owing to the inordinately high levels disinfectant. Furthermore, a system used for bioterrorism remediation must produce essentially zero effluents, in order not to exacerbate the underlying problem.

### SUMMARY OF THE INVENTION

The present invention is directed towards a modular wastewater treatment system that uses multiple treatment processes to neutralize or remove contaminants in the wastewater generated during site biohazardous cleanup or decontamination activities. The basic system incorporates a chemical addition and reaction/contact tank to provide initial chemical treatment based upon specific site situations. The wastewater is then pumped to a centrifuge for solids separation. A polishing sand filter is used to remove fine particulates and carbon adsorption removes dissolved organics. The E33 media removes arsenic present in the effluent water. The final effluent is passed through an ultra filtration unit to further reduce any particulate material in the wastewater. Depending on the specific application, the wastewater can be passed through a reverse osmosis unit to control dissolved salts. The entire system is housed in an ISO container easily transportable to a site ready for use.

Accordingly, it is a primary objective of the instant invention to provide a modular wastewater treatment system that uses multiple treatment processes to superchlorinate, neutralize and remove contaminants in the wastewater generated during site cleanup or decontamination activities resulting from a biohazardous terrorist event.

An additional object of the invention is to provide a multiple treatment process capable of remediating highly halogenated or chemical laden effluent utilizing the self-contained, modular wastewater treatment system of the present invention, so as to permit return of the treated stream to the environment with zero discharge of hazardous effluent.

It is yet a further objective of the instant invention to provide a wastewater treatment system and method that will treat wastewater to meet surface water discharge criteria or reuse criteria for cleanup operations involving highly chlorinated water, or wastewater from chemical agent cleanup.

It is an additional objective of the present invention to teach a wastewater treatment system and method that is user-friendly and easily maintained, needing only one or two operators to operate the system.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a filtration plant flow diagram;

FIG. 2. shows the characteristics of the secondary effluent from the Mill Creek Sewage Treatment Plant;

FIG. 3 shows a summary of the sample collection and analysis program;

FIG. 4 shows the analytical methods that will be for the verification test and the typical detection limits that are achieved by these methods;

FIG. 5 shows the frequency of analysis of various quality control checks;

FIG. 6 shows a summary of analytical accuracy and precision limits for the various analytical parameters (pH, temperature, turbidity, etc.);

FIG. 7 shows a summary of the Arsenic Filtration Test over 10 days;

FIG. 8A shows arsenic filtration results for influent/effluent results for various analytical parameters over 3 days;

FIG. 8B shows arsenic filtration results for influent/effluent results for various analytical parameters over 3 days;

FIG. 8C shows arsenic filtration results for influent/effluent results for various analytical parameters over 2 days;

FIG. 8D shows arsenic filtration results for influent/effluent results for various analytical parameters over 2 days;

FIG. 9 shows a summary of the methyl parathion lab test results over ten days;

FIG. 10A shows the methyl parathion lab test results for influent/effluent results for various analytical parameters over 3 days;

FIG. 10B shows the methyl parathion lab test results for influent/effluent results for various analytical parameters over 3 days;

FIG. 10C shows the methyl parathion lab test results for influent/effluent results for various analytical parameters over 3 days;

FIG. 10D shows the methyl parathion lab test results for influent/effluent results for various analytical parameters over 1 day;

FIG. 11 shows a summary of the de-chlorination test results over eleven days;

FIG. 12A shows the de-chlorination lab test results for raw water for various analytical parameters (pH, TDS, etc.) over eleven days;

FIG. 12B shows lab test results for de-chlorinated water for various analytical parameters (pH, TDS, etc.) over eleven days;

FIG. 12C shows lab test results for filter water for various analytical parameters (pH, TDS, etc.) over eleven days;

FIG. 12D shows the lab test results for treated outlet water for various analytical parameters (pH, TDS, etc.) over eleven days;

FIG. 13A shows the chemicals and consumables used during the EPA test for arsenic, methyl parathion, de-chlorination; and

FIG. 13B shows the chemicals and consumables used during the EPA test for arsenic, methyl parathion, de-chlorination.

### DEFINITIONS AND ABBREVIATIONS

The following list defines terms, phrases and abbreviations used throughout the instant specification. Although the terms, phrases and abbreviations are listed in the singular tense the definitions are intended to encompass all grammatical forms.

As used herein, the term “accuracy” refers to a measure of the closeness of an individual measurement or the average of a number of measurements to the true value and includes random error and systematic error.

As used herein, the term “bias” refers to the systematic or persistent distortion of a measurement process that causes errors in one direction.

As used herein, the term “comparability” a qualitative term that expresses confidence that two data sets can contribute to a common analysis and interpolation.

As used herein, the term “completeness” a qualitative term that expresses confidence that all necessary data have been included.

As used herein, the term “precision” refers to a measure of the agreement between replicate measurements of the same property made under similar conditions.

As used herein, the term “Quality Assurance Project Plan” refers to a written document that describes the implementation of quality assurance and quality control activities during the life cycle of the project.

As used herein, the term “residuals” refers to the waste streams, excluding final effluent, which are retained by or discharged from the technology.

As used herein, the term “representativeness” refers to a measure of the degree to which data accurately and precisely represents a characteristic of a population parameter at a sampling point, a process condition, or environmental condition.

As used herein, the term “standard operating procedure” refers to a written document containing specific procedures and protocols to ensure that quality assurance requirements are maintained.

As used herein, the term “technology panel” refers to a group of individuals which expertise and knowledge of wastewater treatment and homeland security issues.

As used herein, the term “testing organization” refers to an organization qualified by the Verification Organization to conduct studies and testing of technologies in accordance with protocols and test plans.

As used herein, the term “vendor” refers to a business that assembles or sells wastewater treatment equipment.

As used herein, the term “verification” refers to evidence on the performance of in drain treatment technologies under specific conditions, following a predetermined sturdy protocol(s) and test plan(s).

As used herein, the term “verification organization” refers to an organization qualified by the EPA to verify environmental technologies and to issue Verification Statements and Verification Reports.

As used herein, the term “verification report” refers to a written report containing all raw and analyzed data, all QA/QC data sheets, descriptions of all collected data, a detailed description of all procedures and methods used in the verification testing, an all QA/QC results. The Test Plan(s) shall be included as part of this document.

As used herein, the term “verification statement” refers to a document that summaries the Verification Report reviewed an approved by the US EPA.

As used herein, the term “verification test plan” refers to a written document prepared to describe the procedures for conducting a test or study according to the verification protocol requirements for the application of treatment technology. At a minimum, the Test Plan shall include detailed instructions for sample and data collection, sample handling and preservation, precision, accuracy, goals, and quality assurance and quality control requirements relevant to the technology and application.

As used herein, the abbreviation “BOD₅” refers to 5-day biochemical oxygen demand.

As used herein, the abbreviation “COD” refers to chemical oxygen demand.

As used herein, the abbreviation “CRS” refers to chlorine removal system.

As used herein, the abbreviation “DQI” refers to data quality indicators.

As used herein, the abbreviation “U.S. EPA” or “EPA” or “U.S. EPA” are used interchangeably herein and refer to U.S. Environmental Protection Agency.

As used herein, the abbreviation “ETV” refers to Environmental Technology Verification.

As used herein, the abbreviation “ft²” refers to square foot (feet).

As used herein, the abbreviation “gal” refers to gallon.

As used herein, the abbreviation “gpm” refers to gallon per minute.

As used herein, the abbreviation “ISO” refers to International Organization for Standardization.

As used herein, the abbreviation “Kg” refers to kilogram.

As used herein, the abbreviation “kWh” refers kilowatt hour.

As used herein, the abbreviation “L” refers to Liter.

As used herein, the abbreviation “lb” refers to pound As used herein, the abbreviation “Lpm” refers to Liter per minute.

The abbreviation “MBAS” refers to Methylene blue active substances.

The abbreviation “MEFS” as used herein, refers to Mobile Emergency Filtration System.

The abbreviation “MSD” refers to Metropolitan Sewer District of Greater Cincinnati.

The abbreviation “NRMRL” refers to National Risk Management Research Laboratory.

The abbreviation “mg/L” refers to milligram per liter, which is used interchangeably with “ppm”, which refers to parts-per-million.

The abbreviation “mL” refers to milliliter.

The abbreviation “μg/L” refers to microgram per liter.

The abbreviation “ND” refers to “not detected”.

The abbreviation “NSF” refers to NSF International.

The abbreviation “O&M” refers to Operation and maintenance.

The abbreviation “ORP” refers to Oxidization/reduction potential.

The abbreviation “PLC” refers to Programmable logic controller.

The abbreviation “QA” refers to quality assurance.

The abbreviation “QC” refers to quality control.

The abbreviation “USS” refers to UltraStrip System, Inc.

The abbreviation “RCRA” refers to Resource Conservation and Recovery Act.

The abbreviation “RO” refers to reverse osmosis.

The abbreviation “RPD” refers to relative percent deviation.

The abbreviation “SOP” refers to standard operating procedure.

The abbreviation “TBD” refers to the phase “to be determined”.

The abbreviation T&E refers to EPA's Test and Evaluation Facility.

The abbreviation “TKN” refers to total Kjeldahl nitrogen.

The abbreviation “TO” refers to Testing Organization (Shaw Environmental).

The abbreviation “TP” refers to total phosphorus.

The abbreviation “TOC” refers to total organic carbon.

The abbreviation “TSS” refers to total suspended solids.

The abbreviation “UF” refers to ultrafiltration.

The abbreviation “VO” refers to verification Organization (NSF).

The abbreviation “VTP” refers to verification test plan.

### DETAILED DESCRIPTION OF THE INVENTION

The instant invention is directed toward a Multiple Stage Filtration Process, which includes chemical addition/neutralization for de-chlorination, centrifugation, sand filtration, arsenic absorption through E33 media, carbon adsorption, ultra filtration and reverse osmosis. The instantly disclosed system is a modular wastewater treatment system that uses multiple treatment processes to neutralize or remove contaminants in the wastewater generated during site cleanup or decontamination activities.

The basic system incorporates a chemical addition system and a contact tank to provide initial chemical treatment based a specific site situation. De-chlorination process involves dosing of calcium thiosulfate in the stream of wastewater prior to effluent tank. The wastewater may be pumped to a centrifuge, if necessary, for solids removal. A sand filter is used to remove fine particulate and carbon adsorption removes dissolved organics. E33 Filter media absorbs arsenic present in the wastewater. The final effluent is passed through an ultra filtration unit to further reduce any particulate material present in the wastewater. Depending on the specific application, the wastewater can be run through a reverse osmosis unit to control dissolved salts. The entire system is housed in a 40-foot long inter-modal modular steel container unit that can be brought to the site ready to use.

The filtration plant illustrated herein has a capacity to treat approximately 26 gallons per minute (100 Lpm) on a batch or continuous flow basis. This size system is considered a full-scale system and is typical of units that are available for delivery to cleanup sites. Further description of each unit process is given below.

De-Chlorination Process:

The de-chlorination process involves dosing of calcium thiosulfate in the stream of wastewater prior to effluent tank. The chemical reaction with residual chlorine in the water takes place as follows:
In its first reaction, one molecule of thiosulfate combines with two chlorine molecules and produces four molecule of hydrochloric acid plus one molecule of calcium thiosulfite.
   CaS2O3+2Cl2+3H2O----→4HCl+Ca(HSO3)2
The next reaction combines the bisulfite with two more chlorine molecules producing four more molecules of hydrochloric acid plus calcium sulfate and sulfuric acid.
   Ca(HSO3)2+2Cl2+2H2O---→4HCl+CaSO4+H2SO4
The summation of above equations may be expressed in following equation.
   CaS2O3+4Cl2+H2O----→8HCl+CaSO4+H2SO4
A second thiosulfate molecule reacts with one chlorine, producing two hydrochloric acid, calcium sulfate and sulfur. This reaction may take several minutes.
   CaS2O3+Cl2+H2O----→CaSO4+S+2HCl

The wastewater is pumped thorough a pipe network that contains the chemical injection system to internal effluent tank.

The chemical injection system consists of an electronic metering pump, an in-line static mixer, and a chemical storage tank(s) equipped with a mixer. The purpose of the injection system is to introduce chemical agents into the wastewater to neutralize site-specific chemicals used in the decontamination process (e.g. chlorine, oil, grease, etc.)

The injection system can also be used to add chemicals to provide coagulation of suspended particles to enhance the solids separation processes. The metering pump provides control over the dose of chemicals added to the wastewater.

Internal Water Storage Tanks:

The unit is equipped with intermediate water storage tanks prior to the various treatment processes. The storage-tanks are constructed of Grade 304 stainless steel, 2-3 mm thick.

Coagulant (Aluminum Sulfate) is dosed with help of dosing pumps in the stream of water being pumped in the tank for coagulation of suspended solids. In addition, the oil absorbent pads are dropped inside the tank to absorb oil and grease floating on the surface of the water.

The correction of pH can be achieved in this tank by dosing respective chemicals with the help of three dosing pumps. The pH monitor installed on the tank gives instant indication of pH of the water along with temperature. The ORP indicator indicates the ORP reading.

The centrifuge decanter is used for the separation of two or more phases of different specific gravity. The separation takes place within a cylindrical truncated cone shaped rotating drum. The heavier particles and fragments are ‘thrown’ to the periphery of the drum and removed with a rotation internal auger.

Material of Construction of Centrifuge: Stainless steel Grade 304

Feed Pump: Stainless steel with EPDM Seals 26 US Gallons

Temperature Limit: 90 Deg. C.

Chloride Limits: 4000 PPM

Centrifuge System:

The wastewater at most decontamination sites is expected to contain large quantities of grit, dirt, and other suspended solids/residues from the cleaning operation. The centrifuge system provides for the initial removal of suspended solids and contaminants associates with these solids. The centrifuge removes these solids by using centrifugal separation with the heavier particles being thrown to the periphery of the unit and removed from the system. The removal of suspended solids is necessary to meet discharge standards for discharge to a sewer system or for direct discharge or reuse of the treated water. The removal of suspended particulate is also necessary to protect downstream unit process and to increase the efficiency of the filtration and adsorption systems.

Wastewater is pumped from an intermediate water storage tank to the stainless steel centrifuge, which has a design capacity of 26 gpm. The unit is a cylindrical truncated cone-shaped rotating drum. Solids are separated by moving to the outside of the drum and being removed from the system by an auger system.

The centrifuge extractor is used for the separation of two or more different phases of specific gravity, in particular for the clarifying of liquids in which suspended solids are present.

The separation of solids and liquids takes place within a cylindrical truncated cone-shaped rotating drum, upon the periphery of which the heavier, solid phase collects and is continually removed by the internal scroll.

A polyelectrolyte, suitably chosen for its type and specific characteristics, may be added to the product being fed to the machine in order to improve the solid liquid separation. The polyelectrolyte favors the aggregation and thus the sedimentation of the solid particles.

Drum Scroll:

The scroll is located within the drum and is mounted by a collar fitting to the main horizontal shaft of the former. They both turn in the same direction but at slightly different speeds, so that the solid product is drawn along axially, sedimenting and completing its formation as it moves; at the end of its movement, it accumulates in the truncated cone (beach) where it is drained of liquid and expelled from the machine.

Transmission:

A hydrodynamic coupling and belt drive effect transmission from the motor to the drum. The internal scroll is driven by a belt drive from the drum, using epicyclical train reduction gearing. The individual parts in the transmission are specially produced to obtain the optimum processing relationship between the drum and scroll speeds. A mechanical device (shear pin) is located in the drum-augur transmission chain, representing its weakest point, and protecting the reduction gearing, and other moving parts, from any excessive strain that might occur in the drum-scroll coupling during processing.

Effluent from the centrifuge system is then pumped through the media filtration system. This system comprises at least one unit containing sand and activated carbon to remove small particles and any dissolved organics and a granular filer formulated to remove trace metals.

Media Filtration System:

Effluent from the centrifuge system is pumped to the media filtration system. This system consists of one 30-inch diameter stainless steel filter unit. The filtration media is a graded sand finishing with garnet. The filtration system is designed to remove particulate matter down to 5 microns. The filter has a design capacity of 26 gpm.

The filtration system has an automatic backwash system that is activated by time. The backwash water is returned to the internal storage tank. Water used for backwash is piped from the reservoir tank after the sand, E33 and carbon filters and is injected with a flocculent to assist in the backwash process.

Next the effluent from the filtration system is passed through at least one E33 filter system for arsenic adsorbsion. The E33 filter system comprises two 30-inch diameter filters containing granular E33 media used for arsenic removal. Moreover the E33 filter system can be back washed to maintain the efficiency of the E33 filtration.

The carbon adsorption system includes at least one 30-inch diameter filter containing activated carbon absorbers. Activated carbon is used to remove dissolved organics present in the wastewater. This process has achieved total organotin compound concentration in the final effluent of less than 200 ng/litre. It is expected that various dissolved organics will be present in a typical wastewater stream (as measured by BOD₅, COD) and some specific organics that are related to the cleanup process.

Ultrafiltration System:

The next step in the basic system is the ultra filtration system. The system is designed to remove particles in the range or 0.003 to 0.02 micron. This fine filtration will remove virtually all of the particulate material that would be considered suspended solids, and certainly all that are measured by the standard TSS test that uses 0.45-micron filter. Ultra filtration at these micron sizes will also remove many organisms (bacteria and virus), if not previously removed in the cleanup and filtration process.

The effluent from the reservoir tank after the carbon and E33 media adsorption units is pumped via a high-pressure pump to the ultra filtration system. The ultra filtration uses cross-flow filtration through cellulose acetate membranes that typically operate at 65 psi. The design flow is 26 gpm, and has a reject flow rate of 5.3 gpm (20 Lpm).

Material of Construction: Cellulose acetate

Flow Limitations: 100 Ltrs per Min

Temperature Limits: 45 deg Celsius

Chlorides Limits: None.

Reverse Osmosis System:

The system can is configured with a reverse osmosis (RO) system following the ultra filtration unit. Treated wastewater can be passed through the RO unit when required, or the treated wastewater can bypass the RO unit. The RO unit can provide removal of dissolved salts, such as chloride, and dissolved metals such as arsenic and lead. In addition, the RO membranes may also reject certain dissolved organics. The use of RO will depend on the specific application and the end disposal/use of the treated wastewater. If the wastewater is high in dissolved salts, such chlorinated water used for cleaning followed by de-chlorination in the first treatment step, then RO may be needed prior to discharge to reduce the salt content. Trace metals may also, require treatment, particularly for direct discharge of the wastewater

The RO unit has a design flow of 26 gpm to match the overall system design flow, with a reject rate of 2.1 gpm (8 Lpm). The membranes are typically polyamide membranes, which reject molecules in the 0.002 to 0.01 micron (diameter) range. The membranes operate in a cross-flow mode.

The standard RO system operates at a pressure of 240 psi. The reject flow rate ranges from 20-30 percent, depending on the wastewater characteristics. The rejected wastewater is piped back to the holding tank before the centrifuge and gets re-filtered.

Material of Construction: Composite Polyamide

Flow Limitations: 100 Ltrs per Min

Temperature Limits: 45 deg Celsius

Chlorides Limits: 100 ppm

The filtration plan system is operated by a programmable logic controller (PLC) retaining equipment settings and operating processes at all time. The PLC is also equipped with a serial port so that data could be downloaded to a laptop computer.

The filtration plant unit is equipped with two flow meters with tantalizers that report flow rate (gpm) and total processed volume (gallons). The influent flow meter is located before the RO and UF units, while the effluent flow meter is located on the clean water discharge pipe.

Plant Operation:

The Plant is designed to operate automatically once installed.

Ensure that (Flexible Pipe) between de-chlorination Unit and the effluent pump inlet is connected.
The respective dosing chemical is filled in the dosing tank. e.g. Calcium thiosulfate for de-chlorination, Sodium Hydroxide for conditioning pH.
Ensure that the hose connection is made between raw/dirty water tanks to the container dirty water inlet and that the associated float switch is in the effluent/raw water tank. Also, note that the chemical dosing pumps will only start when effluent pump is running.
Ensure that the electrical power is plugged in through cable connector.
Inside the control room turn the door-interlocked isolator to the on position.
Press the start pushbutton on the control panel, the transfer pump will take water from the raw/dirty water tank through dosing pump unit and into the internal effluent tank. During this operation, the dosing pump will also run and dose respective chemical to condition the inlet water.
The centrifuge will also start and reach operating speed after approximately 1 minute through the RPM controller on the control panel.
Start the centrifuge feed pump.
The pumps on all the equipment will start and stop automatically according to the levels in the individual tank (please refer to the flow diagram).
If the plant stops of its own accord and the overload trips light come on. Switching back on the motor starter contained inside the control panel can reset the unit.
   Verification Test Plan (VTP):

It is an objective of the instant invention to provide a system with ultrafiltration and reverse osmosis which will treat wastewater to meet surface water discharge criteria or reuse criteria for cleanup operations involving highly chlorinated water, or wastewater from chemical agent cleanup. Typical effluent requirements for the system need to be site specific but may include those outline in Table 1 below.

### Wastewater Treatment Claims

TABLE 1

| | | | Effluent Characteristics | |
|---|---|---|---|---|
| Parameter | Influent | | after Treatment by SBR | |
| BOD₅ | 100 | mg/L | <10 | mg/L |
| TSS | 100 | mg/L | <5 | mg/L |
| Total Coliform | 10⁶ to 10⁸/100 | ml | <2.2/100 | mL |
| Total chlorine | 100,000 | mg/L | <1.0 | mg/L |

| | | |
|---|---|---|
| | (10%) | |
| Other specific | TBD | TBD |
| chemicals | | |

TBD - to be determined

The experimental design described herein is designed to obtain quantitative and qualitative data on the performance capabilities of the wastewater treatment system, which will serve as the basis for determining the effectiveness of the treatment unit to reduce constituent loads in the wastewater from decontamination activities. The data collected in accordance with the experimental design and sampling analysis plan will be presented in the Verification Report and serve as the basis for the Verification Statement for this technology.

The sections below describe the influent wastewater characterization, the startup procedures, and the actual verification test. Sampling and analysis procedures are presented in the Section designated “Sampling and Analysis Procedures”.

Influent Waste Water:

The EPA has developed a program, through its Environmental Technology Verification Program (ETV), for verifying technologies that treat wastewater from generated from homeland security events. The program uses generic synthesized wastewater to challenge the equipment. This synthetic wastewater should reflect general constituents that could be found in actual contaminated wastewater. The origin of for the basis of the synthetic wastewater will be secondary effluent piped to the T&E Facility from the Cincinnati MSD Mill Creek Sewage Treatment Plant. The synthetic wastewater is then augmented with additional constituents and surrogates to tailor the wastewater to the specific application being verified.

The instantly disclosed unit will be tested for three types of decontamination scenarios.
1) Biological contamination—cleanup with chlorine based materials including chlorine dioxide followed by washing with 10 percent bleach (5.25 percent sodium hypochlorite) solution.
2) Chemical contamination (inorganic)—cleanup of a Lewisite contaminated site, where trivalent arsenic remains as a decontamination byproduct. The synthetic wastewater will include water based cleaning solutions with detergents and alkaline buffers.
3) Chemical contamination (organic)—cleanup using water based solutions containing detergents and neutralizing chemical(s)—organo-phosphorus pesticide (methyl parathion) will serve as a surrogate contaminant.
   Each of these decontamination scenarios is distinctly different in one or more key components that can be expected in the wastewater from the cleanup process. Therefore, three different synthetic wastewater compositions will be used during the verification tests. However, the base composition of the synthetic wastewater will be the same.
   The characteristics of the synthetic contaminant matrix to be diluted with secondary effluent are critical to obtaining a representative test. The typical constituents that will be used to make this wastewater are listed below.
   Oil, Hydrocarbons, general organics
   Diesel fuel
   Motor Oil
      Solids and Particulate
   Sand (50 percent by dry weight)
   Topsoil (50 percent by dry weight)
      Surfactants, Cleaners, Phosphorus Compounds
   Commercial high pressure washer cleaning product (surfactant based)
   Commercial hand washing degreasing product (409, Mr. Clean, etc.)

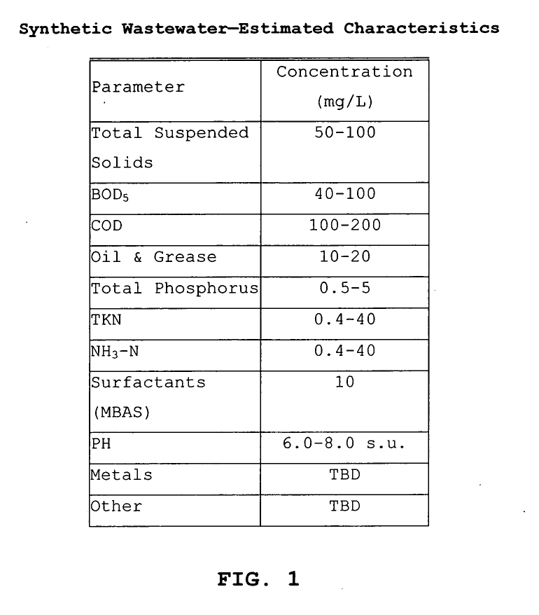

The materials listed above are used to simulate typical contributors to a wastewater stream from sites such as buildings, parking lots, roadways, subways, etc. The base materials will be used to make a synthetic wastewater that has targeted general contaminants levels, as measured by indicator tests, used routinely for wastewater treatment evaluations. FIG. 1 shows the target characteristics for the base synthesized wastewater. Preliminary testing in the laboratory will be performed to set the amounts of the base constituents to achieve the targeted the characteristics.

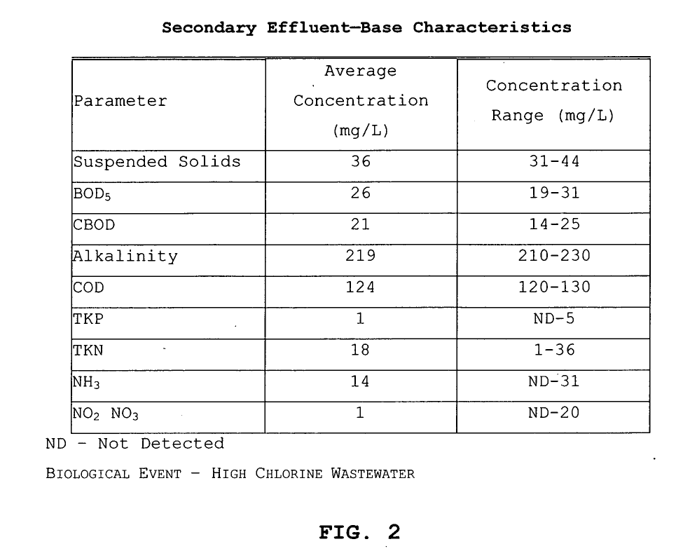

Testing conducted at the T&E Facility has shown the secondary effluent from the Mill Creek Sewage Treatment Plant has the characteristics shown in FIG. 2.

The verification of the cleanup from a biological attack is based on the assumption that a chlorine-based chemical will be the main chemical used for disinfection/deactivation. The use of household bleach (5.25 percent sodium hypochlorite solution) at a ratio of one part bleach per 10 parts water may be used as a wiping agent to decontaminate solid surfaces after a biological terrorism event. A 1:10 solution of bleach and the water would have a chlorine concentration of approximately 2,500 mg/L.

Inorganic Chemical Event—Arsenic Compound:

The verification of the cleanup from a chemical attack using Lewisite is based on the assumption that the cleanup process will use alkaline cleaning solutions to remove the surface arsenic contamination resulting from the chemical inactivation of the chemical agent. Challenge levels for decontamination of facilities in the military are typically 10 mg/m². Concentrations of arsenic for testing purposes will vary between 1 and 5 mg/L. A soluble arsenic salt (arsenic trioxide) will be added to the synthetic wastewater for testing purposes.

Organic Chemical Event—Nerve Agent or Similar Compound:

The verification of the cleanup from a chemical attack by some type of nerve agent or similar compound is based on the assumption the cleanup process will entail a chemical oxidation of the active agent, followed by a thorough cleaning of all surfaces. Testing will assume that there was less than complete reaction between the oxidant and the active chemical, resulting in the need for the removal of the chemical from the waste stream. It is common to use a surrogate to simulate the presence of a nerve agent or similar chemical, and challenge the solids and adsorption systems with the specific surrogate. Organo-phosphorus pesticides, such as methyl parathion, have been used for this purpose. The verification of this event will include the addition of one (1) mg/L of methyl parathion to the synthetic wastewater. This will be added using a stock solution.

Stock Solutions:

A standard base synthetic wastewater mixture be used for all of the verification tests. Constituents including soil, waste oil, and detergent will be added to the secondary effluent from the Mill Creek Sewage Treatment Plant. The surrogates (arsenic salt, bleach, or methyl parathion, depending on the test) will then be added to the synthetic wastewater for each test.

Installation and Startup:

As stated previously, the system is a self-contained modular system that will arrive in a steel container (trailer size) with all systems ready to be setup and checked. The chemical addition system and tanks will be shipped separate setup outside the steel container. The site will provide the influent and effluent holding tanks and support facilities, including water supply, electrical feed, and sewer system for treated wastewater disposal.

Upon arrival, trained personnel will work together to make the necessary connections and finalize all piping, utility, and installation requirements. Installation will follow the instructions outlined in the O&M manual. During installation, the amount of time and type of skilled labor needed to complete the setup will be recorded. The ease or difficulty of setting up the unit will be noted. The setup operation is an important detail when evaluating a mobile treatment system that must be received and made operational quickly in the field.

Once the system is installed, the wet testing and startup process will begin. The influent holding tank will be filled with potable water. Water will then be pumped through each system sequentially to test the condition of all piping, valves, fittings, etc. The system will be checked for leaks and any leaks found will be repaired. The startup will include calibration of flow meters by using a fill and draw method on the influent tank and on intermediate tanks in the system. Each flow meter will be calibrated prior to the start of verification test runs. Once wet testing is complete, the system will be ready for a clean water startup and shakedown run.

All of the startup procedures will follow the O&M manual for the system. Each system will be monitored during the startup period and routine recording of operating conditions will be made by the PLC and written logs. Timers and pump cycles on the various unit processes will be verified and adjusted as needed during the startup.

All of the unit processes are physical or chemical processes. These types of systems, including chemical addition, centrifugation, filtration and adsorption typically stabilize within a few hours of operation. The startup process will progress from one unit process to the next in a sequential manner. The clean water startup will be used to both set the operating conditions for each unit process, verify pump and pressure settings, and to familiarize the operating staff with each unit operation. All adjustments or changes made to the system will be documented in the field log(s).

In addition to the various equipment checks and calibration requirements, at least two sets of sampling and analysis from the influent wastewater tank will be performed. The stock solutions will be added to one batch of water (at least 2,000 gallons) and the influent tank mixed. The synthetic wastewater will be pumped from the influent holding tank and passed into the chemical neutralization/reaction tank. Grab samples after 500 gallons and 1500 gallons will be collected and analyzed for the parameters shown in FIG. 1. This test of the synthetic wastewater system will confirm that the synthetic wastewater can be made within the specifications of the VTP. Additional sampling and analysis may be performed as needed or desired.

Personnel will determine when the startup is complete and the verification test will begin. This decision will be based on reviewing the operating conditions to determine that the system is stable and operating in accordance with operating specifications and O&M manual. When the system is ready for the start of the verification test, the TO will notify the VO and with the VO concurrence, the Verification Test will be initiated.

Verification Testing:

The system is designed to treat wastewater to meet typical discharge standards established by State and local government to protect surface water and groundwater or for discharge to a sewer system. This verification test will establish the effluent quality achieved by the system for wastewater from three different types of homeland security events.

There will actually be three verification tests performed under this single VTP and experimental design. The system will be tested using three different synthetic wastewaters as hereinafter described. The effectiveness of the system to reduce constituent concentrations in the base synthetic wastewater will be tested in all three verifications. This will be achieved by collecting and analyzing samples of the influent wastewater, treated effluent waters from various treatment steps and the final effluent from the treatment system. In addition to the general parameters, the specific parameters will be monitored for each of the three synthetic wastewater that will be tested.

Objectives:

The objectives for the experimental design for this verification test are:

Determine the treatment performance of the system to remove key target constituents, including TSS, BOD₅, COD, O&G, TKN, ammonia and TP.
Determine the treatment performance of the system to remove the key target constituent from a biological attack where chlorine is the primary deactivation/disinfection chemical. Total residual chlorine and free chlorine will be the key constituents monitored.
Determine the treatment performance of the system to remove an inorganic contaminant, such as that resulting from a chemical attack where lewisite is the primary agent and cleaning is based on chemical oxidation of the target compound, resulting in a residual arsenic contamination of surfaces. Total arsenic will be the key constituent monitored.
Determine the treatment performance of the system to remove the key target constituent from a chemical attack where a nerve agent is the primary agent and cleaning is based on chemical oxidation of the attack agent, with a portion of the agent remaining unoxidized and transferred to the wastewater during washdown operations or personal protective equipment (PPE) decontamination. Methyl parathion will be used as a surrogate and will be the key constituent monitored.
Evaluate and thoroughly document the O&M requirements for the system for each type of wastewater.
Monitor and record information on solids residuals produced by the system.
Monitor and record the labor time, chemical use, power consumption of the entire system, and other pertinent data.
   Verfication Test Period:

Each verification test will include 10 days of operation of the system. Therefore, the overall testing period will include 30 days of operation, 10 days per verification, three verification wastewater types. The test unit will operate at approximately 26 gpm, so a 10,000 gallon batch of influent water will take approximately 6.5 hours to process. Operating daily for ten days, there will be 10 sets of performance data for each verification test, representing 100,000 gallons of wastewater treated. Physical chemical systems such as the instantly disclosed invention do not need an acclimation period, therefore the ten days of data will present a sufficiently long run to properly evaluate the expected performance of the unit.

Flow Monitoring

The system will be operated in batch mode during the verification test, operating approximately 6 to 7 hours per day. The influent holding tank will be filled with secondary effluent and the various stock solutions added to make the synthetic wastewater. The synthetic wastewater will be pumped from the influent holding tank and into the system unit. Subsequently, the wastewater is pumped to the centrifuge and to an intermediate holding tank. The wastewater is then pumped again through the sand filter and carbon adsorption system to another intermediate tank. A high pump moves the wastewater to the ultra filtration system. Finally, the treated water is pumped once again at high pressure to the RO unit and then flows to the discharge location.

Primary flow monitoring will by reading the flow meters located on each pumped line. There are two flow meters located in the system, one before the sand and carbon filter which measures influent, and one after ultra filtration which measures treated effluent. The flow rate is set for each unit process or group of processes by adjusting the flow control valves on the influent or effluent lines from the various treatment steps. The flow rate for each flow meter will be recorded through out the day in the operating log, see attached APPENDIX A.

A second check on the flow rates of reach operating day will be performed by recording the volume of water processed from the influent holding tank, the volume accumulated in the effluent holding tank, and the total run time. These data will provide direct measurements of the total volume processed each day and the average flow rate for the day.

All flow data will be provided in the final report. The measurement of influent flow and the flow for each unit process will provide redundant flow measurement of the system. In addition, monitoring total volume processed from the influent holding tank and total effluent received in the effluent holding tank will provide a basis for checking the flow rate data.

Sampling and Analysis:

Two primary sampling locations will be used for the verification test. The primary locations will be the untreated wastewater influent and the treated effluent from the entire system. Additional details regarding sampling procedures, preservation and storage, chain-of-custody, and analytical methods are described in Section 6.0. Influent samples will be collected from the intermediate holding tank before the centrifuge (while flow is occurring). Effluent samples will be collected from the treated effluent discharge point.

Analytical Parameters—All Tests:

The sampling and analytical program will consist of collecting and analyzing samples for a number of base parameters, with special analytical parameters added based on the specific testing event being performed. Temperature, pH, turbidity, alkalinity, and TSS samples will be collected once per day. Analysis will be performed at the T&E facility with results reported to the project team as the data are made available.

Organic (COD) and hydrocarbon (O&G) samples will be collected once per day. Analysis will be performed at an off-site laboratory. Results will be reported back to the TO approximately 2-3 weeks after the samples are submitted to the laboratory.

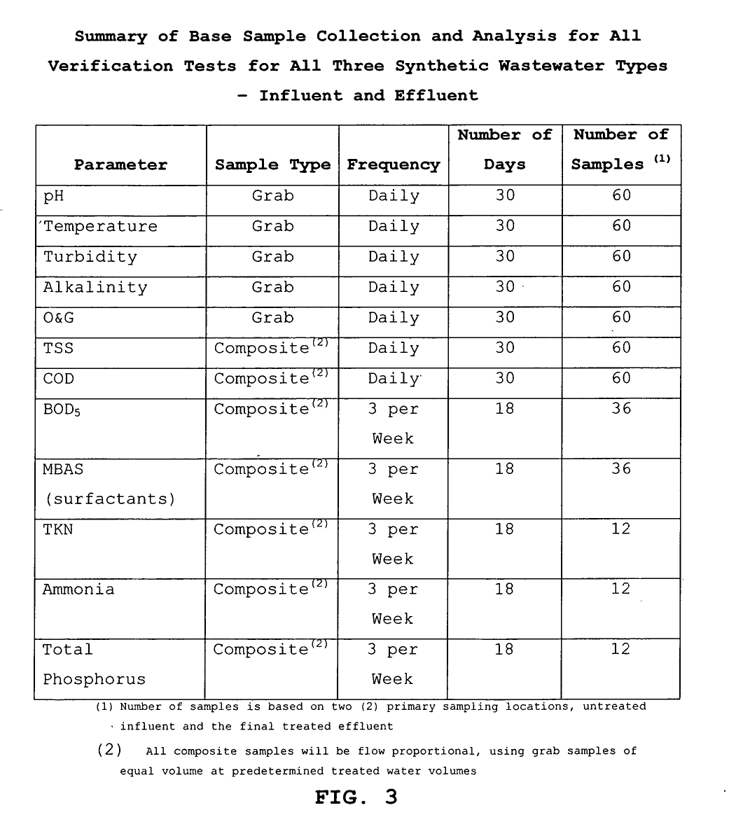

Surfactants (MBAS), BOD₅, and nutrients (TKN, ammonia, phosphorus) are not primary performance parameters (i.e. secondary parameters) for this study and will be analyzed on a less frequent basis. Three days per week, composite samples will be collected for these parameters. BOD₅ and MBAS analyses will be conducted on the composite samples collected each sampling day. The daily nutrients samples collected over the course of the week will be analyzed as a one-week composite sample submitted to the laboratory at the end of the week. The daily composite aliquots will be collected in separate bottles, preserved, and stored at 4° Celsius until the entire composite sample is collected. FIG. 3 summarizes the base sample collection and analysis program for each of the three tests.

Biological Event—High Chlorine Wastewater:

The verification of the cleanup from a biological attack is based on the assumption that chlorine will be the main chemical used for disinfection/deactivation. Sampling and analysis for Total Residual Chlorine and Free Chlorine will be added to the VTP for the ten days of verification testing, using this influent wastewater.

Inorganic Chemical Event—Arsenic Compound:

The verification of the cleanup from a chemical attack resulting in an inorganic chemical residual will be represented by the decontamination of a lewisite contamination. Arsenic will be added to the synthetic wastewater. Sampling and analysis for Total Arsenic will be added to the VTP for the ten days of verification testing, using this influent wastewater. FIG. 3 shows a summary of the sample collection and analysis program

Organic Chemical Event—Nerve Agent or Similar Compound:

The verification of the cleanup from a chemical attack by some type of nerve agent or similar compound is based on the assumption the cleanup process will use an oxidizing agent to neutralized the agent, but that there will remain a low-level residual of the attack chemical requiring treatment. Organo-phosphorus pesticides have been selected as a surrogate for the nerve agent. This verification of this event will include the addition of 1 mg/L of an organophosphorus pesticide, such as methyl parathion, to the synthetic wastewater. Sampling and analysis for the pesticides will be added to the VTP for the ten days of verification testing, using this influent wastewater. FIG. 3 shows a summary of the sample collection and analysis program.

Residuals:

Solids are removed from the centrifuge on a continuous basis and are pumped into a 55-gallon waste drum. The solids concentration and total volume of solids flow from the centrifuge will be monitored on a daily basis during the test. The solids flow from the centrifuge to a solids holding and thickening tank. The tank allows the solids to separate further providing a more concentrated sludge. Overflow from the tank flows to the influent holding tank and is reprocessed in the system. When the testing is complete, arrangements will be made to have the sludge removed by a licensed hauler. Drums will be stored on-site pending finalization of disposal arrangements.

Operations and Maintenance:

The system will be started and operated in accordance with the supplied O&M Manual. Trained personnel will operate, maintain, and monitor the system during the test period. The TO will keep records showing operating conditions and maintenance performed.

The units will be visually inspected for any signs of incorrect performance or abnormal conditions. The operator checklist will be maintained during the verification test and will become part of the operations record for the final verification report.

The O&M manual also provides information on each unit operation and a troubleshooting section. These detailed checklist and description of operation will serve as the basis for review of the system operation and maintenance. A field logbook maintained by the TO will provide written notes for each day of operations. This logbook will also become part of the permanent record on the operation of the unit.

Any maintenance performed will be logged in an on-site maintenance log. The TO will date and initial the maintenance logbook. If any extraordinary maintenance is required, the personnel will inform the TO and document the maintenance performed. In addition to the operating records kept at the site, the PLC monitors several critical parameters for the operation of the unit processes. The PLC monitors pump cycles, flow, electrical components and the operation of floats and sensors related to the operation of the system. These conditions are recorded and can be adjusted if needed. Flow rates, volume of water processed, amount of chemical solutions pumped from the feed tanks, power consumption, backwash flow rates, and related operational data will be recorded by the TO operators in the operational log. The measurements of residue volumes and weights will be recorded after any sludge pumping activities.

Each time the stock solutions for the synthetic or chemical solutions for the chemical injection are prepared, the mass of chemical used, the volume of water used, and other notations will be placed in the operating log.

Power consumption will be monitored on a daily basis. A standard electrical power meter (watt meter) will be installed at the site. Meter readings will be taken at least daily throughout the test and will be recorded in the logbook. At the end of the test, the meter will be sent out for a calibration check.

Specific operating conditions for individual unit process will also be recorded. Examples include:
Centrifuge rotation rate and other pertinent data will be recorded.
The sand filter backwash frequency and rates, the pressure drop across the filter and other observations will be made.
The same is true for the activated carbon system.
The ultrafiltration and RO units will be monitored for filtrate flow rates, pressure on the systems, and for RO the reject stream flow rate. The reject stream will be addressed in the same manner as residual solids.

The amounts of consumable supplies or the need for related equipment expenses will be recorded in the operating log. These may include media addition or change-out of the sand or carbon systems, membrane changes in the ultrafiltration or RO units, or lamp replacement for the UV system. It is expected that these changes will be infrequent, but need to be part of the operating record as they can significantly impact system operating costs and uptime. The personnel time to complete these O&M activities will also be recorded in the log book by the TO.

Any other observations on the operating condition of the unit, or the test system as a whole, will be recorded by the TO in the log book. Observations of changes in effluent quality based visual observations, such as color change, oil sheen, obvious sediment load, etc., will also be recorded in the log book by the TO.

The operating and maintenance logbook(s) will be important records for use during the verification report preparation. These logs will provide the information to validate the flow and operating conditions during the test periods. Further, they will serve as the basis for making qualitative performance determinations regarding the unit's operability and the level/degree of maintenance required. These logs will be maintained by the TO during the start up and testing period.

Once all testing is complete, the system will be cleaned and ready for shipment from the site. The time to decontaminate and clean the system, and ready it for shipment will be recorded. The ease or difficulty of demobilization will also be observed and recorded, as these factors are important in a mobile treatment system used for this type of application. Sampling locations and analysis plan—procedures:

There are two primary sampling locations in system. The two primary locations are the influent sampling location just upstream of the treatment processes in the system and the final treated effluent sampling location located just downstream of the ultrafiltration, RO or UV unit discharge, whichever is the last unit process. Both sampling locations are set up so that grab or flow weighted composite samples can be collected.

Grab samples will be collected directly into the sample bottle (no intermediate container). Collecting flow-weighted composites is straight forward as all test conditions call for a steady flow rate for set periods of time. Therefore, a set sample volume (e.g. 500 mL) can be collected on a cumulative flow basis and a flow-weighted composite will be obtained. All composite samples will flow weighted based on the collection of equal volumes of sample on a volume throughput basis (e.g. every 2,000 gallons). A clean plastic or glass container (depending on the analysis list) will be used to collect the individual grab sample. The sample bottles will be prepared with preservative by the laboratory.

In addition to the influent, and effluent samples, samples will also be collected of solids removed from the centrifuge and from any sludge removed from the site during the test period. These centrifuge solids samples will be manual grab samples collected from the solids sludge holding tank. When the tank is 50 percent full of sludge, the sludge will be removed from the holding tank by pumping the sludge to a tanker truck. A sludge sample will be obtained by collecting individual aliquots of sludge at two locations and two depths (four aliquots) in the holding tank. These aliquots will be combined into one container. The sludge sample container will be cooled and sent to the laboratory for analysis. The site operators will record the volume of sludge pumped from the tank, each time sludge is removed from the system.

Sampling Frequency:

Sampling type, frequency and the analytical list is presented in under the Experimental Design—Sampling and Analysis section. Summary tables showing all of the sampling for each Verification Test Phase is given in Tables 5-2 through 5-6. There will be thirty (30) sampling days, ten days for each verification test condition for the primary locations. The base sampling type and analysis will be consistent for these primary sampling locations (system influent and effluent) over the three verification tests. Additional sampling and analyses will be performed specific to the three event types and conditions (one biological and two chemical events).

Sample Preservation and Storage:

The composite samples will be well mixed and poured into individual sample containers containing appropriate preservatives. The laboratory will provide the sample bottles required for the various analyses. The bottles will come with preservative in the bottles and labeled by analysis type.

The samples will be logged in the field notebook (same information as label above plus samplers name), placed in coolers with ice to maintain temperature, and delivered to the laboratory the same day. Alternatively, if refrigerator space is available in the physical lab, the sample swill be stored in the refrigerator until the sampling is complete each day.

Analytical Methods:

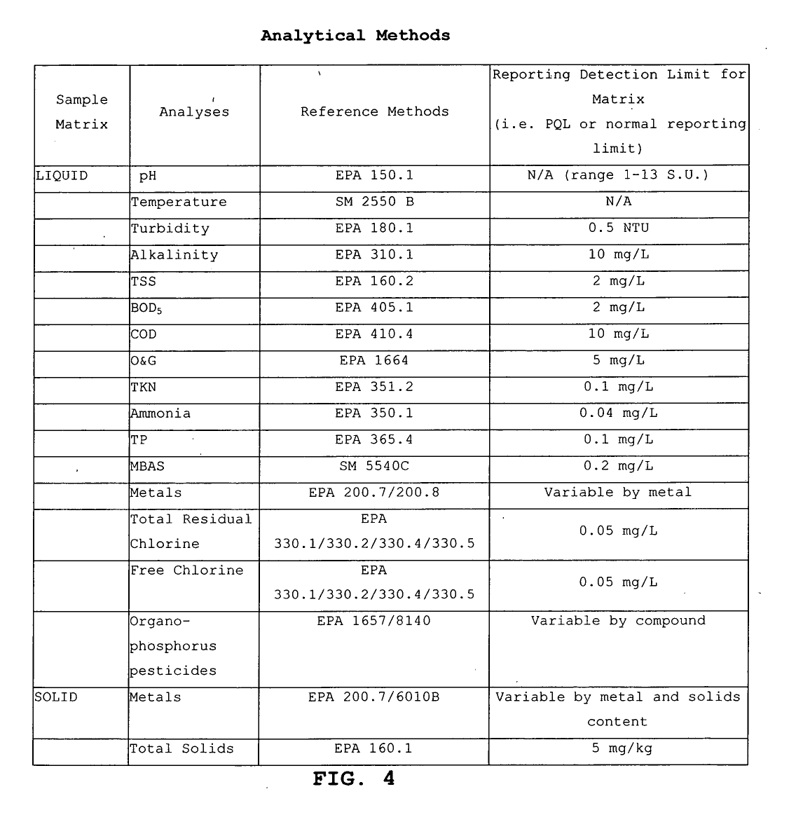

All analytical methods used during the verification test will be EPA approved methods or methods from Standard Methods for the Examination of Water and Wastewater, 20^{th} Edition. FIG. 4 shows the analytical methods that will be for the verification test and the typical detection limits that are achieved by these methods.

Several parameters will be measured by the field staff in the laboratory, including pH, temperature, and turbidity. The off-site contract laboratory will conduct all other analyses. Both the field and laboratory will report all results with all associated QC data. The results will include all volume and weight measurements for the samples, field blank results, method blanks, spike and spike duplicate results, results of standard check samples and special QC samples, and appropriate calibration results. All work will be performed within the established QA/QC protocol as described in the Quality Assurance Project Plan (Section 7), and as outlined in the analytical SOPs. Any deviations from the standard test procedures or difficulties encountered during the analyses will be documented and reported with the data.

Flow Meter Calibration:

As described herein, there will be redundant measurements of flow rate and total volume processed by the system. The flow meters will be calibrated by measuring the draw down over time in the influent tank. There will be several flow meters in the system. Each flow meter will be calibrated at the beginning of each verification test and all flow rate data recorded for each unit process. The total volume of wastewater processed each day will be recorded based upon the influent holding tank draw down and will be checked against the volume accumulated in the effluent holding tank. These redundant measurements will provide a good measurement of both total volume processed each day and the flow rates used.

Quality Assurance and Quality Control—Project Plan:

The purpose the quality assurance/quality control program used during the VTP is to ensure that data and procedures are of measurable quality and support the quality objectives and test plan objectives for this verification test. The plan has been developed with guidance from the U.S. EPA's Guidance for Quality Assurance Project Plans and Guidance for the Data Quality Objectives Process. The QA/QC plan is tailored to this specific test plan and requirements for verification of the system in this application. The QA/QC plan is written as part of the Verification Test Plan and should be read and used with the VTP as a reference. The VTP contains descriptions of various requirements of the QA/QC Plan and they are incorporated by reference at several locations.

Verification Test Data—Data Quality Indicators (DQI):

Several Data Quality Indicators (DQIs) have been identified as key factors in assessing the quality of the data and in supporting the verification process. These indicators are:
Precision
Accuracy
Representativeness
Comparability
Completeness

Each DQI is described below and the goals for each DQI are specified. Performance measurements will be verified using statistical analysis of the data for the quantitative DQI's of precision and accuracy. If any QA objective is not met during the tests, an investigation of the causes will be initiated. Corrective Action will be taken as needed to resolve the difficulties. Data failing to meet any of the QA objectives will be flagged in the Verification Report, and a full discussion of the issues impacting the QA objectives will be presented.

Precision:

Precision refers to the degree of mutual agreement among individual measurement and provides an estimate of random error. Analytical precision is a measurement of how far an individual measurement may deviate from a mean of replicate measurements. Precision is evaluated from analysis of field and laboratory duplicates and spiked duplicates. The standard deviation (SD), relative standard deviation (RSD) and/or relative percent difference (RPD) recorded from sample analyses are methods used to quantify precision. Relative percent difference is calculated by the following formula:

$$RPD = \frac{\vert {C}_{1} - {C}_{2} \vert}{ \overline{C}} \times 100 \%$$

Where:
C₁=Concentration of the compound or element in the sample
C₂=Concentration of the compound or element in the duplicate
C=Mean of samples

Field duplicates will be collected of both influent and effluent samples. The field duplicates will be collected at a frequency of one duplicate for every ten samples collected of influent and effluent. The laboratory will run duplicate samples as part of the laboratory QA program. Duplicates are analyzed on a frequency of one duplicate for every ten samples analyzed. The data quality objective for precision is based on the type of analysis performed. Table 7-2 shows the laboratory precision that has been established for each analytical method. The data quality objective varies from a relative percent difference of ±10% to ±30%.

Accuracy:

Accuracy is defined for water quality analyses as the difference between the measured value or calculated sample value and the true value of the sample. Spiking a sample matrix with a known amount of a constituent and measuring the recovery obtained in the analysis is a method of determining accuracy. Using laboratory performance samples with a known concentration in a specific matrix can also monitor the accuracy of an analytical method for measuring a constituent in a given matrix. Accuracy is usually expressed as the percent recovery of a compound from a sample. The following equation will be used to calculate.

Percent Recovery:
Percent Recovery=[(A_{T}−Aᵢ)/Aₛ]×100%

Where:

A_{T}=Total amount measured in the spiked sample

Aᵢ=Amount measured in the un-spiked sample

Aₛ=Spiked amount added to the sample

During the VTP, the laboratory will run matrix spike samples at frequency of one spiked sample for every 10 samples analyzed. The laboratory will also analyze liquid and solid samples of known concentration as lab control samples. The accuracy objectives by parameter or method are shown in Table 7-2.

Comparability:

Comparability will be achieved by using consistent and standardized sampling and analytical methods. All analyses will be performed using U.S. EPA or other published methods as listed in the analytical section (Table 6-2). Any deviations from these methods will be fully described and reported as part of the QA report for the data. Comparability will also be achieved by using National Institute of Standards (NIST) traceable standards including the use of traceable measuring devices for volume and weight. All standards used in the analytical testing will be traceable to verified standards through the purchase of verifiable standards, and maintaining a standards logbook for all dilutions and preparation of working standards. Comparability will be monitored through QA/QC audits and review of the test procedures used and the traceability of all reference materials used in the laboratory.

Representativeness:

Representativeness is the degree to which data accurately and precisely represent a characteristic population, parameter at a sampling point, a process condition, or an environmental condition. The test plan design calls for grab and composite samples of influent and effluent to be collected and then analyzed individually or as flow-weighted composites. The sampling locations for the samples are designed for easy access and are directly attached to the pipes that carry the wastewater. This design will help ensure that a representative sample of the flow is obtained in each grab or composite sample bottle.

The sample handling procedure includes a thorough mixing of the composite container prior to pouring the samples into the individual containers. The laboratory will follow set procedures (in accordance with good laboratory practice) for thorough mixing of any samples prior to sub-sampling in order to ensure that samples are homogenous and representative of the whole sample. The system will be operated in a manner consistent with the supplied O&M manual, so that the operating conditions will be representative of a normal installation and operation for this equipment.

Representativeness will be monitored through QA/QC audits (both field and laboratory), including review of the laboratory procedures for sample handling and storage, review and observation of the sample collection, and review of the operating logs maintained at the test site. The Verification Organization or their representative will perform at least two field and lab audits.

Completeness:

Completeness is a measure of the number of valid samples and measurements that are obtained during a test period. Completeness will be measured by tracking the number of valid data results against the specified requirements in the test plan. Completeness will be calculated by the following equation:
Percent Completeness=(V/T)×100%

Where:

V=number of measurements that are valid

T=total number of measurements planned in the test

The goal for this data quality objective will be to achieve minimum 80% completeness for samples scheduled in the test plan.

Analytical Methods:

All of the analytical methods used during the verification test will be U.S. EPA approved methods or methods from Standards Methods for the Examination of Water and Wastewater, 20^{th} Edition. FIG. 4 shows the analytical methods that will be for the verification test and the typical detection limits that are achieved by these methods.

Analytical Quality Control:

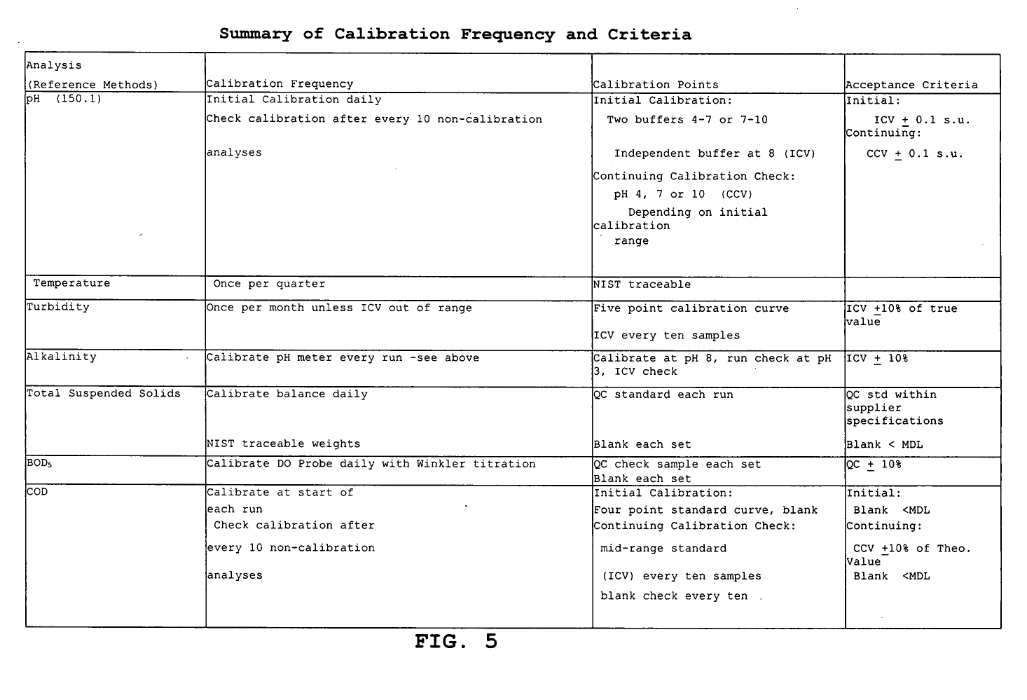

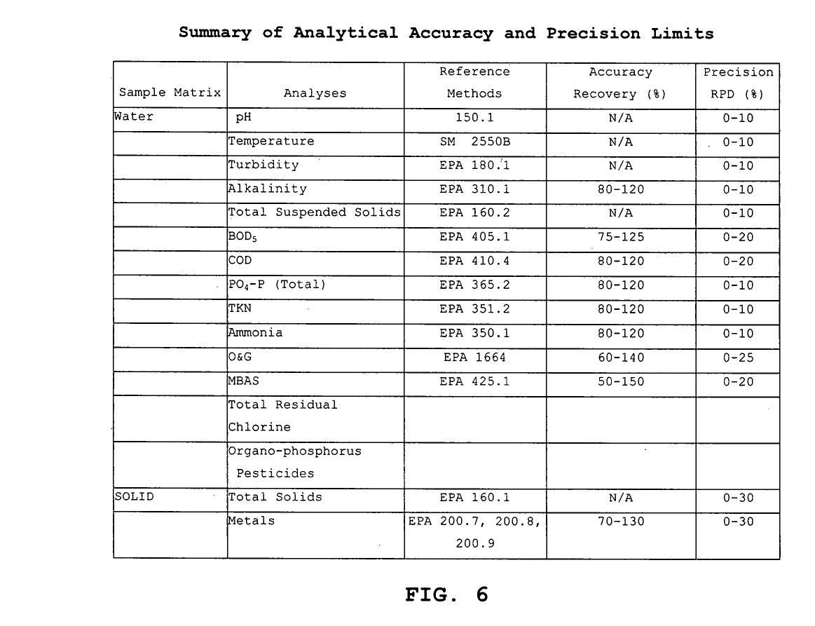

The quality control procedures for blanks, spikes, duplicates, calibration of equipment, standards, reference check samples and other quality control measurements will follow the guidance in the EPA methods, SOP's and Shaw's Quality Assurance and Quality Control Manual. FIG. 5 shows the frequency of analysis of various quality control checks. FIG. 6 shows the quality control limits that will be used by the laboratory for these analyses and to ensure compliance with the DQI's for accuracy and precision. Field and laboratory duplicates will be performed at a frequency of one duplicate per ten samples collected. Samples will be spiked for accuracy determination at a frequency of one sample per ten samples analyzed by the laboratory. Accuracy and precision will be calculated for all data using the equations presented in earlier in this section.

Laboratory blank water of known quality will be used for all laboratory analyses. If contamination is detected in the blank water, the analysis will be stopped and the problem corrected. Laboratory blanks, method blanks and any other blank water data will be reported with all analytical results.

Laboratory control samples, where applicable, will be used to verify the methods are performing properly. The control samples will be blank water spiked with constituents from standards obtained from certified source material. Balances will be calibrated each day with NIST traceable weights. A calibration logbook is maintained to demonstrate the balances are accurate.

Field blanks will be prepared at the test site and sent to the laboratory with the samples for two sampling events.

Data Reduction, Handling, and Reporting:

Equations:

The data analysis will include the calculations of removal efficiency and various statistics. The equations to be used in the data analysis are provided below.

$$\begin{matrix}\text{Removal Efficiency} \\ ( as percent )\end{matrix} = \frac{( mg \text{/} L \text{influent} - mg \text{/} L \text{effluent} )}{\begin{matrix}100 \\ ( mg \text{/} L \text{in the influent} )\end{matrix}}$$

Sample Mean=y_{bar}=Σv/n
(Average)

Where:

y_{bar}=sample mean

Σv=sum of the sample values

n=number of samples
Standard Deviation=s=(Σ(y−y_{bar})²/n)^{1/2}

Where:

S=sample standard deviation

y=individual sample value

y_{bar}=sample mean
95% Confidence=y_{bar}±t_{α/2}(s/n^{1/2})
Interval Where:

y_{bar}=sample mean

s=sample standard deviation

n=number of samples

t_{a/2}=Student's t-distribution

with n−1 degrees of freedom,

with α/2=0.025 and

t_{α/2}=2.068 for n=25

Arsenic Filtration Test Data:

During the arsenic filtration test the challenge water was mixed with Arsenic Trioxide and or Sodium arsenate to obtain 5 ppm concentration. In addition the challenge water was mixed with oil/grease, surfactants, and diatomaceous earth of appropriate quantity.

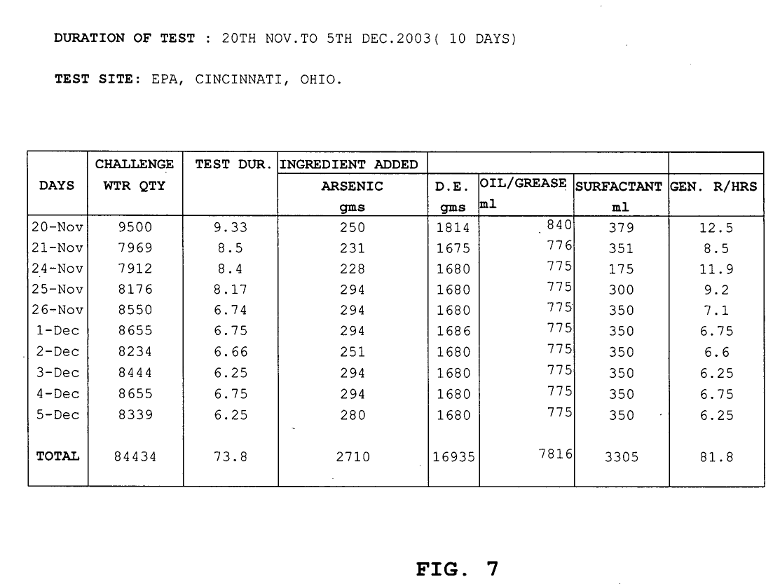

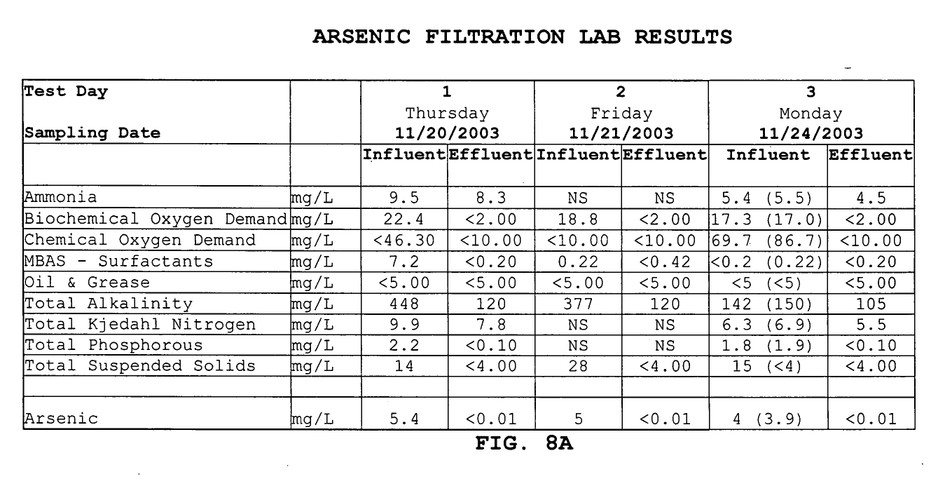

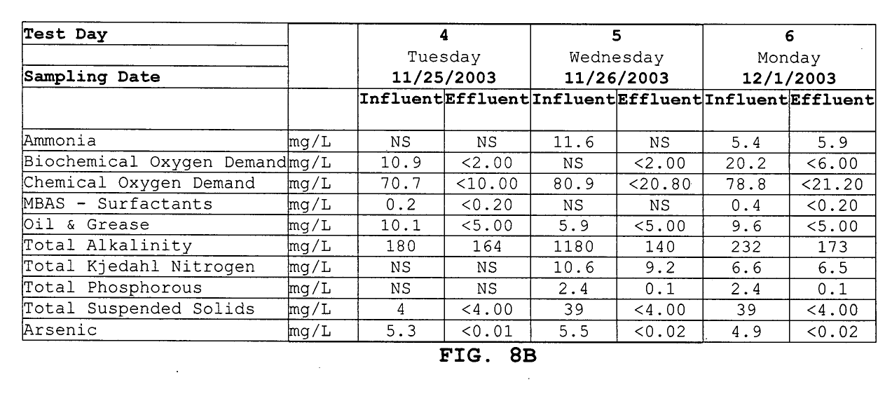

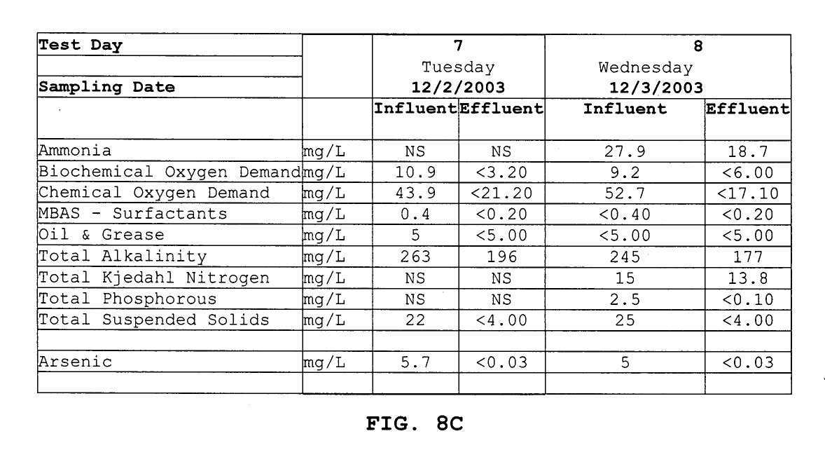

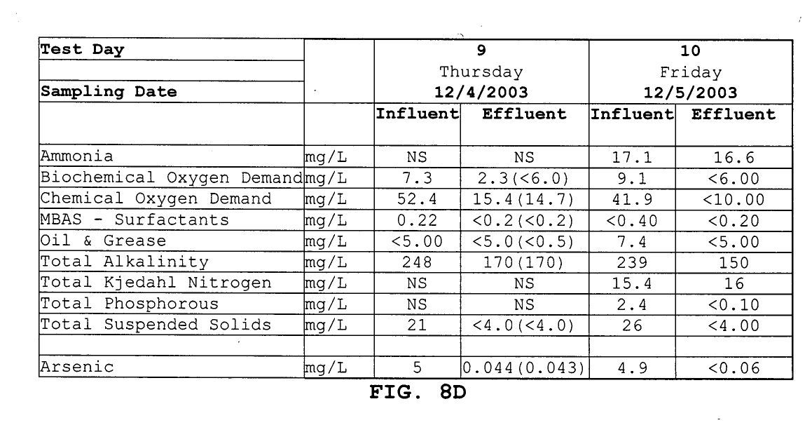

During filtration process, coagulant added in the stream of water before pumping it into the internal storage tank. Floating oil-absorbing pad in the internal storage tank absorbed oil and grease present in the water. The water was passed through the centrifuge and then through the media filters. Initially water was taken through sand and carbon and then passed through E-33 media filters. The water from E-33 outlet contained less than 5 ppb of Arsenic. To achieve further filtration level water was passed through Ultra filtration with rejection of approx. 15 LPM. Please find data log sheets recorded during the 10 day arsenic trial in APPENDIX A. FIG. 7, outlines the Arsenic Filtration Test Summary and the FIGS. 8A to 8D summarizes the Arsenic Filtration Lab Results.

Methyl Parathion Filtration Test Data:

During the methyl parathion filtration test the challenge water was mixed with methyl parathion to obtain a 5 ppm concentration. In addition the challenge water was mixed with oil/grease, surfactants, and diatomaceous earth of appropriate quantity.

During filtration process, coagulant (Aluminium sulphate) added in the stream of water before pumping it into the internal storage tank. Floating oil-absorbing pad in the internal storage tank absorbed oil and grease present in the water.

Water was passed through centrifuge and then through media filters. The challenge water was taken through sand and carbon only and E-33 media filters were bypassed throughout the process. The methyl parathion was removed by carbon media filter to no detectable level. To achieve further filtration level water was passed through Ultra filtration with rejection of approx. 15 LPM.

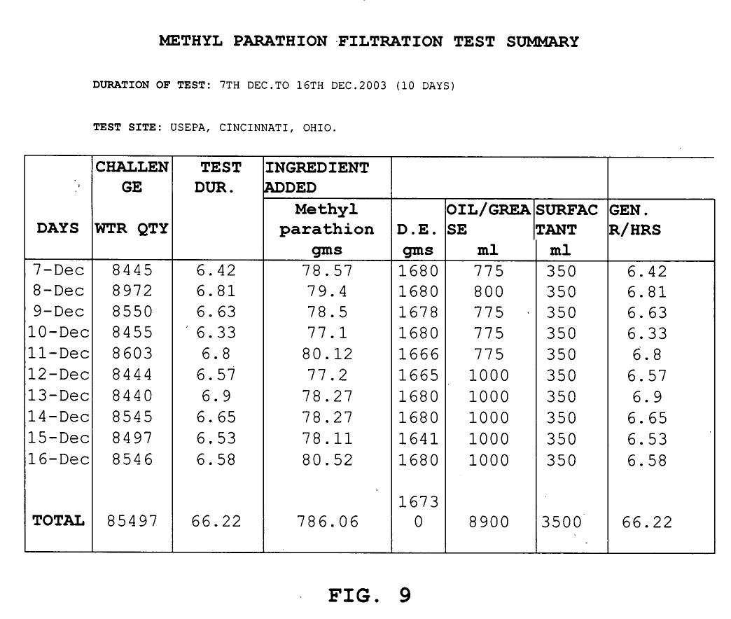

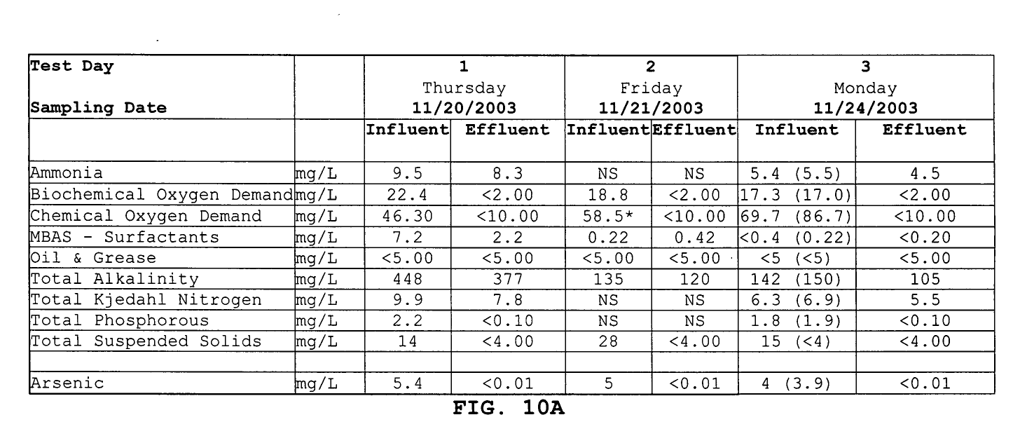

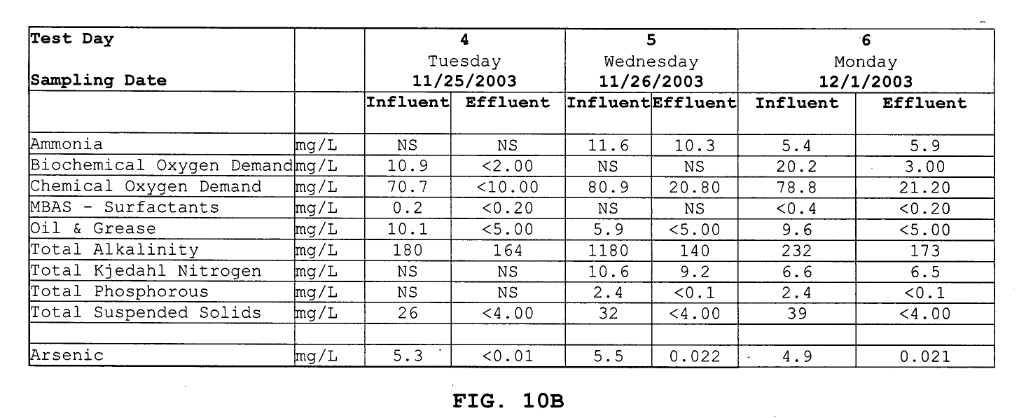

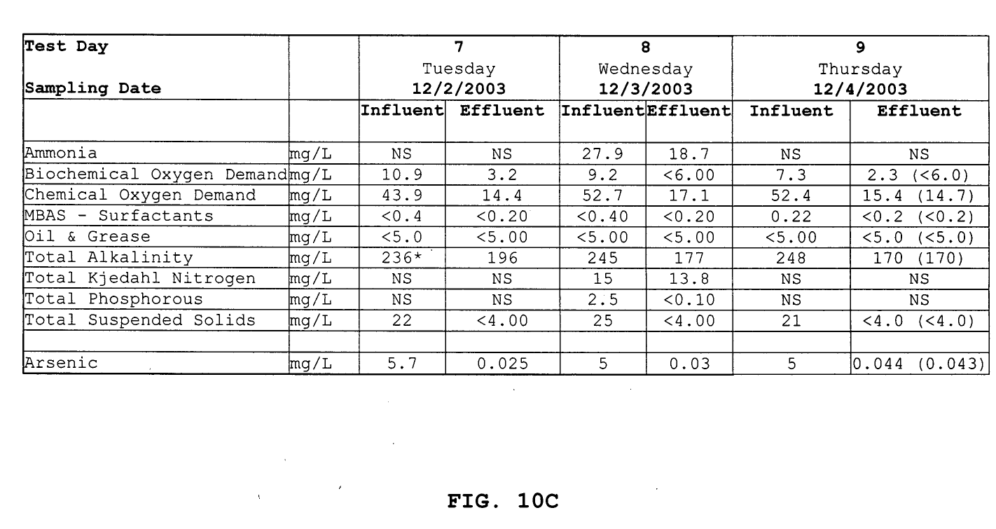

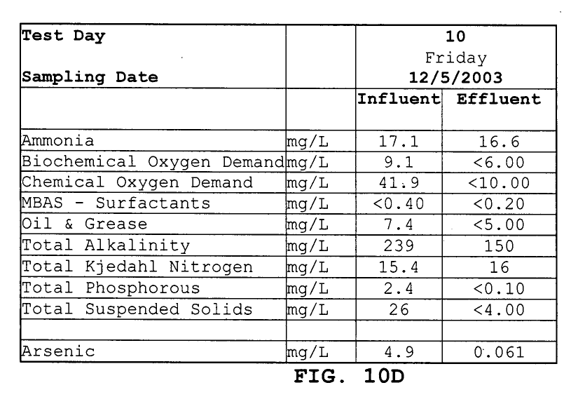

Please find below the data log sheet recorded during the methyl parathion trial. Please find data log sheets recorded during the 10 day methyl parathion trial in APPENDIX B. FIG. 9, outlines the methyl parathion Filtration Test Summary and the FIGS. 10A to 10D summarizes the methyl parathion Filtration Lab Results.

De-Chlorination Test Data:

During the De-chlorination test the challenge water was mixed with 10% concentrate bleach solution to obtain 2500 ppm or more concentration of chlorine. In addition the challenge water was mixed with oil/grease, surfactants, and diatomaceous earth of appropriate quantity.

During filtration process, the challenge water was passed through de-chlorination unit, where captor was injected in the stream of water before passing through reaction vessel.

At the beginning of third reaction vessel caustic (sodium hydroxide of 50% conc.) was injected to maintain pH above 7. In addition to caustic dosing pump installed on the de-chlorination unit, other dosing pumps installed inside the filtration plant were used for dosing pH.

It was noticed that after adding captor and caustic, the water in the internal storage tank turned into milky white colour. Although this white colour precipitation was removed in the centrifuge in the form of fine powder, water remained white colour even after ultra filtration. When water was passed through RO the recovery of water was between 15 to 20%.

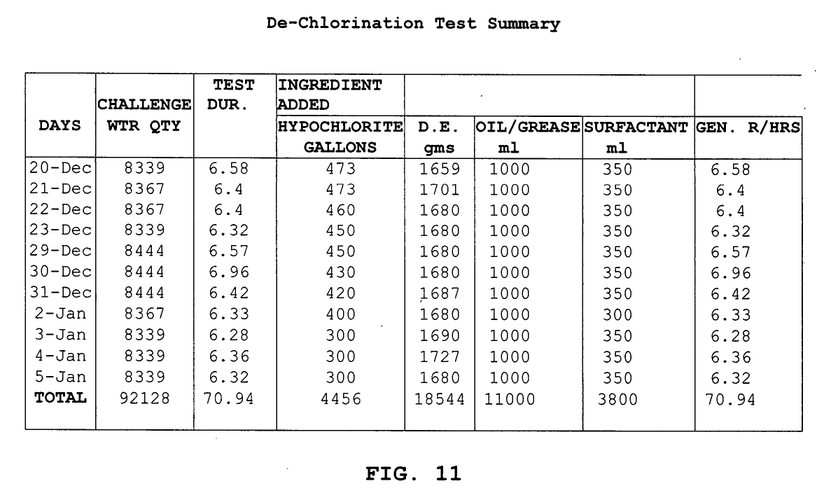

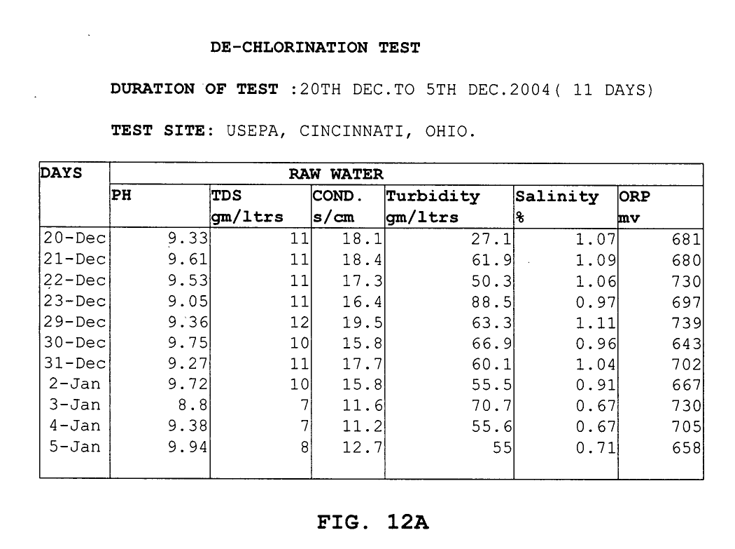

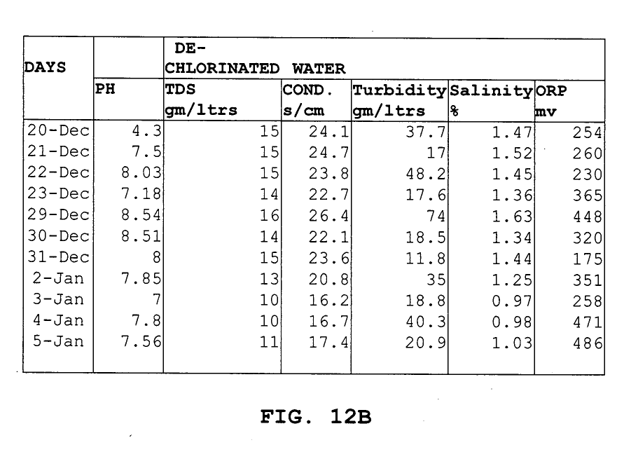

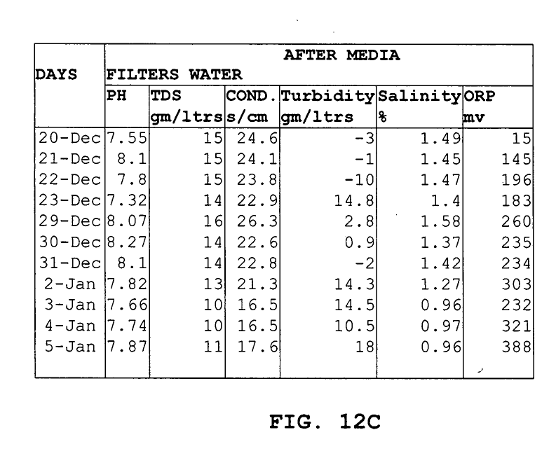

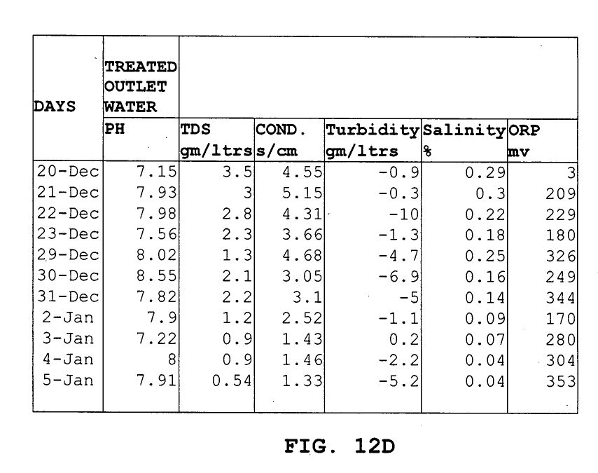

Floating oil-absorbing pad in the internal storage tank absorbed oil and grease present in the water. Please find the data log sheets in APPENDIX C, recorded during the 11 day de-chlorination trial. FIG. 11, outlines the de-chlorination test summary and the FIGS. 12A to 12D summarizes the de-chlorination lab results.

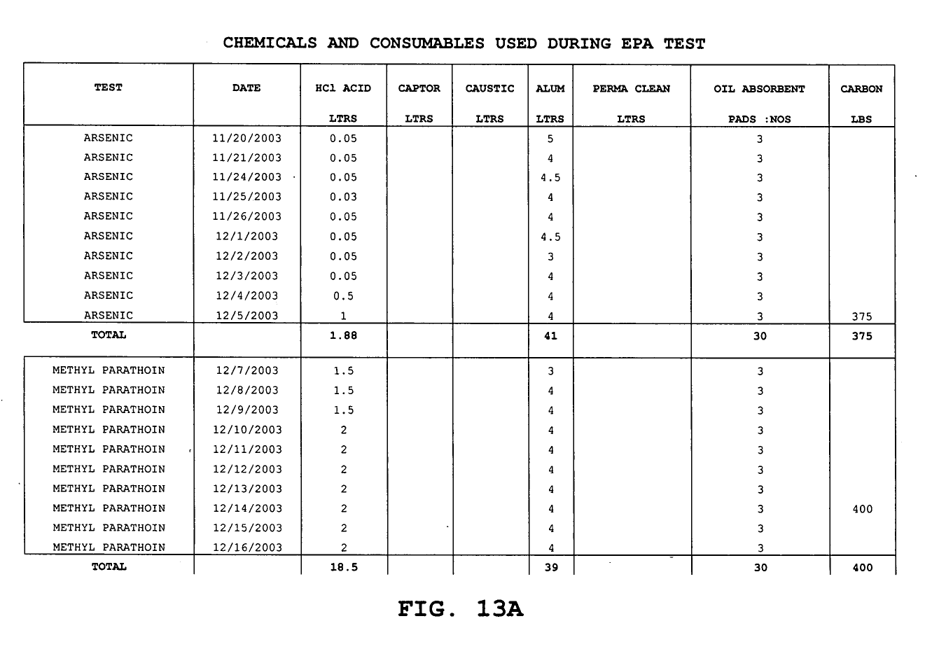

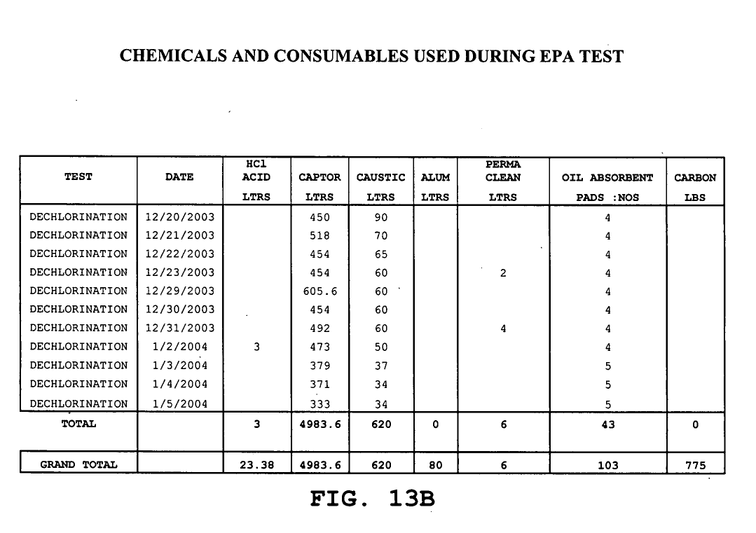

FIG. 13 illustrates the chemicals and consumables that were used during the EPA testing. Whereas FIG. 14 illustrate the cost involved.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method for treating wastewater generated as a result of a biohazardous terrorist event comprising:
(a) introducing at least one chlorine containing agent into said influent wastewater at a level of at least 100,000 mg/L to produce a super-chlorinated effluent effective to extirpate contaminants contained within said influent;
(b) neutralizing said super-chlorinated effluent with an effective amount of a de-chlorinating agent with said super-chlorinated effluent, thereby providing a substantially neutralized final effluent;
(c) transporting said neutralized effluent though at least one reverse osmosis unit to lower the dissolved solids contained therein, whereby a final treated effluent is generated; and
said final treated effluent is discharged.

2. The method for treating wastewater as set forth in claim 1, wherein said final effluent in said combining step is fluidly coupled to a media filtration unit comprising at least one polishing sand filter effective to remove fine particulates, at least one carbon adsorption unit effective to remove dissolved organics, and at least one E33 filter media adsorption unit effective to adsorb trace metals present in said wastewater.

3. The method for treating wastewater as set forth in claim 1, wherein said final effluent unit is transported through an ultrafiltration system adapted to remove particles in the range of about 0.003 to about 0.02 micron.

4. The method for treating wastewater as set forth in claim 1, wherein said de-chlorinating agent is calcium thiosulfate.

5. The method for treating wastewater as set forth in claim 1, wherein said de-chlorinating agent is calcium thiosulfate.

6. The method for treating wastewater as set forth in claim 1, wherein said chlorine containing agent is chlorine dioxide.

7. The method for treating wastewater as set forth in claim 1, wherein said chlorine containing agent is sodium hypochlorite.
